(19) United States
(12) Patent Application Publication
(10) Pub. No.: US 2018/0011372 A1
(43) Pub. Date: Jan. 11, 2018

(54) POLARIZER, MANUFACTURING METHOD THEREOF AND DISPLAY DEVICE

(71) Applicant: BOE TECHNOLOGY GROUP CO., LTD., Beijing (CN)

(72) Inventors: Jiuxia YANG, Beijing (CN); Feng BAI, Beijing (CN)

(21) Appl. No.: 15/540,134

(22) PCT Filed: Nov. 8, 2016
(86) PCT No.: PCT/CN2016/104971

§ 371 Date: Jun. 27, 2017

(30) Foreign Application Priority Data
Jan. 4, 2016 (CN) 201610004287.4

(51) Int. Cl. G02F 1/1335; G02B 5/30

(52) U.S. Cl. CPC G02F 1/133528; G02B 5/3025; G02F 2001/133567; G02F 2001/133562; G02F 1/133606; G02F 1/133514; G02F 2001/133607; G02F 1/133611

(57) ABSTRACT

A polarizer, a manufacturing method thereof and a display device are provided. The polarizer, including: a base substrate and a quantum rod layer disposed on a side of the base substrate, wherein the quantum rod layer includes a plurality of quantum rods arranged in a same direction. The polarizer can improve the utilization rate of light, and improve the brightness of the display panel, and hence achieve image display with high brightness and high color gamut.

### TECHNICAL FIELD

Embodiments of the present invention relate to a polarizer, a manufacturing method thereof and a display device.

### BACKGROUND

In general, a liquid crystal display (LCD) panel mainly includes: an array substrate, a color filter (CF) substrate and a liquid crystal layer located between the array substrate and the CF substrate. The array substrate includes: a base substrate, a gate electrode disposed on the base substrate, a gate insulating layer disposed on the gate electrode, an active layer disposed on the gate insulating layer, a signal line layer (including a source electrode and a drain electrode arranged in the same layer) disposed on the active layer, an insulating layer disposed on the signal line layer, and a pixel electrode disposed on the insulating layer and electrically connected with the drain electrode through a via hole passing through the insulating layer. The main steps of manufacturing the LCD panel includes: forming an array substrate and a CF substrate, and cell-assembling the array substrate and the CF substrate. For example, in a cell-assembly process, firstly, the array substrate and the CF substrate are respectively subjected to alignment film coating and photo alignment processing; secondly, liquid crystals are injected between the array substrate and the CF substrate, and sealant is adopted for sealing; and finally, the obtained product is cut into single panels, and the LCD panel is formed by attaching two polarizers with polarization directions perpendicular to each other on the upper and lower sides of the single panel respectively. The polarizer disposed above the CF substrate is referred to as an upper polarizer (CF POL), and the polarizer disposed below the array substrate is referred to as a lower polarizer (TFT POL).

However, because a polarizer only allows light with a vibration direction parallel with a transmission axis direction of the polarizer to pass through the polarizer, backlight will suffer from 50% loss after passing though the lower polarizer, thereby reducing the utilization rate of the backlight.

### SUMMARY

Embodiments of the invention provides a polarizer, a manufacturing method thereof and a display device, in order to solve the problem of lower utilization rate of backlight caused by a polarizer in conventional technique.

Embodiments of the invention provide a polarizer, comprising: a base substrate and a quantum rod layer disposed on a side of the base substrate, wherein the quantum rod layer comprises a plurality of quantum rods arranged in a same direction.

Embodiments of the invention further provide a display device, comprising a display panel, the display panel comprising a color filter (CF) substrate, an array substrate, a liquid crystal layer disposed between the CF substrate and the array substrate, an upper polarizer disposed on a side of the CF substrate away from the liquid crystal layer, and a lower polarizer disposed on a side of the array substrate away from the liquid crystal layer, wherein at least the lower polarizer is any one of the polarizers according to embodiments of the invention.

Embodiments of the invention further provide a manufacturing method of a polarizer, comprising: forming a pattern of a quantum rod layer on a base substrate, wherein the quantum rod layer comprises a plurality of quantum rods arranged in a same direction.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1a is a schematic structural sectional view of a polarizer provided by the first embodiment of the present invention;

FIG. 1b is a schematic diagram illustrating polarization principle of a polarizer provided by one embodiment of the present invention;

FIG. 2 is a schematic structural sectional view of a polarizer provided by the second embodiment of the present invention;

FIG. 3a is a schematic structural sectional view of a polarizer provided by the third embodiment of the present invention;

FIG. 3b is a schematic structural sectional view of another polarizer provided by the third embodiment of the present invention;

FIG. 4 is a flow diagram illustrating a manufacturing method of a polarizer provided by an embodiment of the present invention;

FIG. 5 is a flow diagram illustrating another manufacturing method of a polarizer provided by an embodiment of the present invention;

FIG. 6a is a schematic structural sectional view of a display panel provided by an embodiment of the present invention;

FIG. 6b is a schematic structural sectional view of another display panel provided by an embodiment of the present invention;

FIG. 7a is a schematic structural sectional view of another display panel provided by an embodiment of the present invention; and

FIG. 7b is a schematic structural sectional view of still another display panel provided by an embodiment of the present invention.

### DETAILED DESCRIPTION

In order to make objects, technical details and advantages of the embodiments of the invention apparent, the technical solutions of the embodiments will be described in a clearly and fully understandable way in connection with the drawings related to the embodiments of the invention. Apparently, the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present invention belongs. The terms “first,” “second,” etc., which are used in the description and the claims of the present application for invention, are not intended to indicate any sequence, amount or importance, but distinguish various components. Also, the terms such as “a,” “an,” etc., are not intended to limit the amount, but indicate the existence of at least one. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly.

Embodiments of the present invention provide a polarizer, a manufacturing method thereof and a display device, which are used for solving the problem of low utilization rate of backlight caused by a polarizer in conventional technique.

The first embodiment of the present invention provides a polarizer. As illustrated in FIG. 1a, the polarizer includes: a base substrate 11 and a quantum rod layer 12 disposed on a side of the base substrate 11. The quantum rod layer 12 includes a plurality of quantum rods 13 arranged in a same direction (with consistent alignment). The quantum rods are, for example, rod-shaped nanocrystals.

For example, as illustrated in FIG. 1b, the plurality of quantum rods 13 in the quantum rod layer 12 are arranged in parallel with each other, and long-axis directions 131 of the quantum rods 13 are arranged in a same direction (with consistent alignment). In FIG. 1b, long-axis directions 131 of the quantum rods 13 are parallel with the base substrate 11. The arranged in a same direction, for example, includes the long-axis directions 131 arranged in a same direction.

The essence of emission of the quantum rods is that inner cores (namely quantum dots) of the quantum rods can be excited by light excitation to emit light. As the quantum rods have directivity and can perform linearly polarized emission, the quantum rod layer can convert light passing through the quantum rod layer into polarized light. As the quantum rods have high internal quantum efficiency, a large amount of light of backlight can be converted into polarized light. Thus, the conversion efficiency can be high; the light loss caused by the adoption of an absorption polarizer can be avoided; utilization rate of the backlight can be improved; and brightness of the display panel can be improved. As excitation spectra of quantum rod materials can have narrow full width at half maximum (FWHM), the display can have wider color gamut area. Thus, the quantum rod layer is employed to achieve image display with high brightness and high color gamut.

As illustrated in FIG. 1b, the long-axis directions of the quantum rods can excite polarized light with longer wavelength than the original incident light source after the quantum rods absorbing non-polarized light. Non-polarized light L1 is converted into linearly polarized light L2 after L1 passes through the quantum rod layer; light parallel with the long-axis directions is reflected; and light perpendicular to the long-axis direction can pass through the quantum rod layer. A polarization direction of the linearly polarized light L2 is perpendicular to the long-axis directions of the quantum rods.

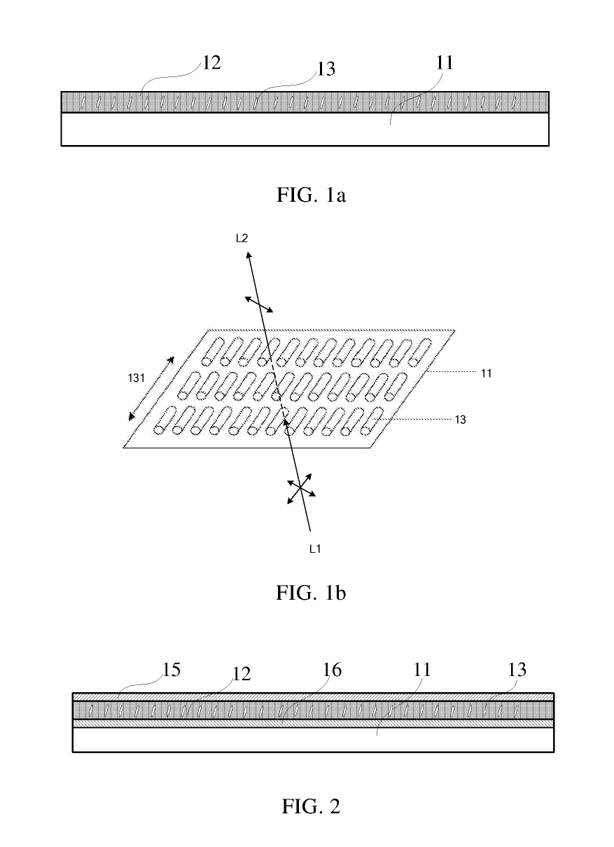

When the quantum rod layer is made from electroluminescent materials, the quantum rod layer itself can produce polarized light under the action of an electric field. Therefore, the second embodiment of the present invention further provides a polarizer. As illustrated in FIG. 2, the polarizer includes: a base substrate 11 and a quantum rod layer 12 disposed on a side of the base substrate 11. The quantum rod layer 12 includes a plurality of quantum rods 13 arranged in a same direction (with consistent alignment). In order to drive the quantum rod layer 12 to produce polarized light, the polarizer further includes a first electrode 15 disposed on a side of the quantum rod layer 12 away from (facing away from) the base substrate 11; and a second electrode 16 disposed on a side of the quantum rod layer 12 close to (facing) the base substrate 11. In the embodiment of the present invention, “facing away from”, for example, refers to “away from”, and “facing”, for example, refers to “close to”.

For example, in a working state, a positive voltage and a negative voltage are applied to the first electrode 15 and the second electrode 16 respectively, so that a uniform electric field can be formed between the first electrode 15 and the second electrode 16. Under the action of the electric field, the quantum rods are excited by the electric field to generate electron-hole pairs, and electrons subjected to transition from valence band to conduction band are in an unbalanced state and will be subjected to transition from the conduction band to the valence band and be subjected to recombination. During transition, photons are produced during the transition from the conduction band to the valence band, so that the quantum rod layer can generate polarized light under the action of the electric field.

Therefore, when the polarizer further includes the first electrode disposed on the side of the quantum rod layer away from (facing away from) the base substrate, and the second electrode disposed on the side of the quantum rod layer close to (facing) the base substrate, voltage difference is formed by applying voltage to the quantum rod layer by utilization of the first electrode and the second electrode, and then the electric field is produced, so that the quantum rods can be excited to emit light, and hence the polarized light required for image display can be produced. The backlight and the lower polarizer are not required to be additionally arranged, and can be replaced by the polarizer provided by the embodiment of the invention. Therefore, the manufacturing process of the display substrate can be simplified; the production cost can be reduced; the light-and-thin design of the display panel can be achieved; the light loss caused by the adoption of an absorption polarizer can be also avoided; and the utilization rate of the backlight can be improved. Meanwhile, the polarized light emitted by the quantum rod layer directly enters an electrode layer, a liquid crystal layer and the like, so that the embodiment can improve the utilization rate of light, improve the brightness of the display panel, and hence achieve image display with high brightness and high color gamut.

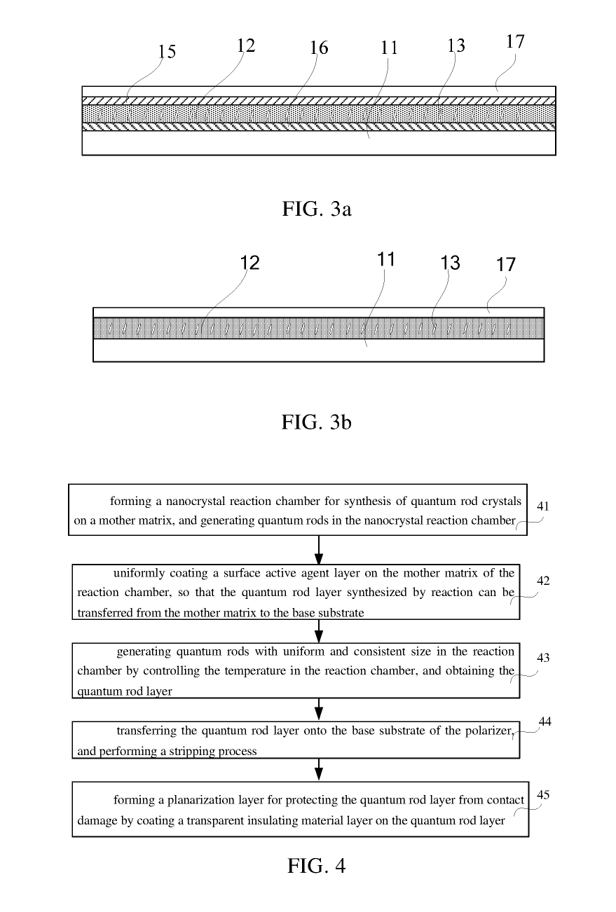

Moreover, as the polarizer must be directly attached beneath the array substrate in the process of manufacturing the display panel, the quantum rod layer may be damaged in the attaching process. In order to avoid this case, as illustrated in FIGS. 3a and 3b, the polarizer provided by the third embodiment further includes a planarization layer 17 disposed on a side of the quantum rod layer away from (facing away from) the base substrate.

The planarization layer 17 is employed to protect the quantum rod layer 12 from contact damage. Meanwhile, the contact area between the polarizer and the array substrate can also be increased; the attaching firmness of the polarizer on the array substrate can be increased; and the probability of the disengagement of the polarizer from the array substrate can be reduced.

Moreover, the quantum rod layer 12 can be made from any material selected from the group consisted of cadmium selenide, cadmium sulfide, zinc sulfide, zinc selenide, calcium sulfide and calcium selenide, limitations are not imposed thereto.

As the material such as cadmium selenide, cadmium sulfide, zinc sulfide, zinc selenide, calcium sulfide and calcium selenide belongs to direct gap semiconductors, and the band gap can well match with the visible spectrum, the above-mentioned material can absorb most visible light and convert the absorbed visible light into polarized light, so that the utilization rate of the backlight can be improved. In addition, the technology of forming the quantum rod layer by utilization of the material is relatively mature, source of raw material is rich, and the production cost can be reduced.

On the basis of the same invention concept, the fourth embodiment of the present invention provides a manufacturing method of a polarizer. The manufacturing method includes: forming a pattern including a quantum rod layer on a base substrate, the quantum rod layer includes a plurality of quantum rods arranged in a same direction (with consistent alignment).

The polarizer manufactured by the method includes the quantum rod layer, and the quantum rod layer includes a plurality of quantum rods arranged in a same direction. As the quantum rods have directivity and can perform linearly polarized emission, the quantum rod layer can convert light passing through the quantum rod layer into polarized light. Moreover, the utilization rate of light can be improved, so that image display with high brightness and high color gamut can be achieved. Meanwhile, the brightness of the display panel can also be improved.

Moreover, the quantum rod layer can be formed by coating or crystal growth.

The technique of forming the quantum rod layer by coating or crystal growth is relatively mature and can reduce the production difficulty.

For example, forming the quantum rod layer by crystal growth includes the following steps.

Forming a quantum rod layer in a reaction chamber; transferring the quantum rod layer in the reaction chamber onto the base substrate; and performing planarization treatment on the quantum rod layer transferred onto the base substrate, so that the quantum rod layer can have a flat surface.

In addition, forming the quantum rod layer by coating can include the following steps.

Forming a solution coating by coating a mixed solution containing quantum rods on the base substrate; precuring the solution coating, so that viscosity of the solution in the solution coating can satisfy a requirement of nanoimprint lithography; forming a quantum rod layer including regularly arranged quantum rods by stamping on the precured solution coating through nanoimprint lithography; and performing a planarization treatment on the quantum rod layer, so that the quantum rod layer can have a flat surface.

The content of the quantum rods in the mixed solution can be in a range of 1%-5%.

When the content of the quantum rods in the mixed solution is in a range of 1%-5%, the concentration range not only can avoid the weak polarization function of the polarizer due to too sparse quantum rods in the formed quantum rod layer caused by too low content of the quantum rods in the mixed solution, but also can avoid the influence of the polarization function due to the superimposition phenomenon of the quantum rods in the formed quantum rod layer caused by too high content of the quantum rods in the mixed solution.

The mixed solution can also contain an organic solvent and curable material.

For example, the organic solvent can be at least one selected from the group consisted of ethyl methyl ketone, methyl isobutyl ketone (MIBK), ethylene glycol monomethyl ether, 1,4-butyrolactone, ethyl 3-ethoxypropionate (EEP), butyl carbitol, butyl carbitol acetate, propylene glycol methyl ether (PGME), propylene glycol methyl ether acetate (PGMEA) and diethylene glycol ethylmethyl ether (DGEME).

For example, the curable material is resin material. The resin mainly includes acrylic resin and epoxy resin. For example, the acrylic resin can be any one selected from the group consisted of methyl acrylate, ethyl acrylate, methyl methacrylate (MMA), ethyl methacrylate, polyester acrylate, polyurethane acrylate and epoxy acrylate; and the epoxy resin can be any one of aliphatic epoxy resin and bisphenol A epoxy resin.

The content of the curable material in the mixed solution is also different according to different selected curable material. When the curable material is epoxy resin, the content of the curable material in the mixed solution can be 1%-10%; and when the curable material is acrylic resin, the content of the curable material in the mixed solution can be 15%-20%.

For example, a content of the organic solvent in the mixed solution is in a range of 60%-80%.

For example, when the content of the organic solvent in the mixed solution is in a range of 60%-80%, the solution coating with uniform film thickness can be formed, and the weak polarization function caused by the quantum rods with too low density can be avoided.

Description will be given below to the process of forming the quantum rod layer in the polarizer provided by the embodiment of the present invention, by crystal growth, with reference to specific examples. As illustrated in FIG. 4, the process includes the following steps.

S41: forming a nanocrystal reaction chamber for synthesis of quantum rod crystals on a mother matrix, and generating quantum rods in the nanocrystal reaction chamber.

S42: uniformly coating a surface active agent layer on the mother matrix of the reaction chamber, so that the quantum rod layer synthesized by reaction can be transferred from the mother matrix to the base substrate.

S43: generating quantum rods with uniform and consistent size in the reaction chamber by controlling the temperature in the reaction chamber, and obtaining the quantum rod layer.

S44: transferring the quantum rod layer onto the base substrate of the polarizer, and performing a stripping process.

S45: forming a planarization layer for protecting the quantum rod layer from contact damage by coating a transparent insulating material layer on the quantum rod layer. The step includes: firstly, coating a layer of thermosetting material on the quantum rod layer; and secondly, curing the thermosetting material by thermosetting process, and forming the planarization layer. For example, the curing time is about 30 min, and the temperature is about 250° C.

In addition, the planarization layer can also be made from photocurable material. The forming process of the planarization layer can refer to the conventional technique. No further description will be given here.

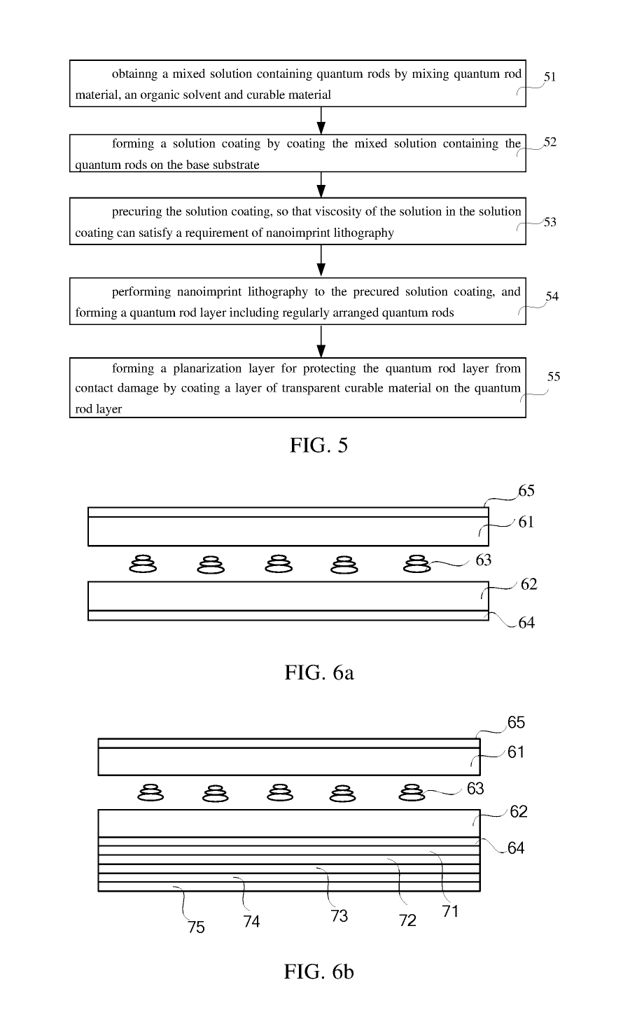

The process of forming the quantum rod layer by crystal growth has been described above. Detailed description will be given below to the process of forming the quantum rod layer by coating. As illustrated in FIG. 5, the process includes the following steps.

S51: obtaining a mixed solution containing quantum rods by mixing quantum rod material, an organic solvent and curable material.

For example, a content of the quantum rods in the mixed solution is in a range of 1%-5%. When the content of the quantum rods in the mixed solution is in a range of 1%-5%, the concentration range not only can avoid the weak polarization function of the polarizer due to too sparse quantum rods in the formed quantum rod layer caused by too low content of the quantum rods in the mixed solution, but also can avoid the influence of the polarization function due to the superimposition phenomenon of the quantum rods in the formed quantum rod layer caused by too high content of the quantum rods in the mixed solution.

For example, the content of the organic solvent in the mixed solution is in a range of 60%-80%. When the content of the organic solvent in the mixed solution is in a range of 60%-80%, the solution coating with uniform film thickness can be formed, and the weak polarization function caused by too low density of the quantum rods can be avoided.

S52: forming a solution coating by coating the mixed solution containing the quantum rods on the base substrate, the coating process is carried out using a smooth roller coating, an anilox roller coating, a blade coating, a spray coating or a curtain coating.

S53: precuring the solution coating, so that viscosity of the solution in the solution coating can satisfy a requirement of nanoimprint lithography. A precuring process can be performed by thermosetting or photo-curing. In the manufacturing process, in order to reduce the production cost, the precuring process usually adopts the thermosetting manner. When the thermosetting process is adopted, the solution coating is heated at the temperature of 220° C. for about 20 min.

S54: performing nanoimprint lithography to the precured solution coating, and forming a quantum rod layer including regularly arranged quantum rods.

S55: forming a planarization layer for protecting the quantum rod layer from contact damage by coating a layer of transparent curable material on the quantum rod layer. The processes in the step are the same with the processes in the step S45. No further description will be given here.

On the basis of the same invention concept, an embodiment of the present invention further provides a display panel. As illustrated in FIG. 6a, the display panel includes a CF substrate 61, an array substrate 62, a liquid crystal layer 63 disposed between the CF substrate and the array substrate, a lower polarizer 64 disposed on a side of the array substrate away from (facing away from) the liquid crystal layer, and an upper polarizer 65 disposed on a side of the CF substrate 61 away from (facing away from) the liquid crystal layer 63. At least the lower polarizer 64 is the polarizer as described above.

Another embodiment of the present invention further provides a display panel, in which a polarizer can adopt the mode of forming linearly polarized light by electroluminescence. As illustrated in FIG. 6b, the display panel further includes a first diffuser 71, a first prism sheet 72, a second prism sheet 73, a second diffuser 74 and a reflector 75. For example, the first prism sheet 72 and the second prism sheet 73 can be perpendicularly arranged to improve brightness of backlight. The diffusers are employed to obtain more uniform luminous effect. Linearly polarized light reflected by quantum rods is converted into non-polarized light after the linearly polarized light passes through the diffusers, and the non-polarized light is reflected by the reflector and reutilized, so that the utilization rate of light can be further improved.

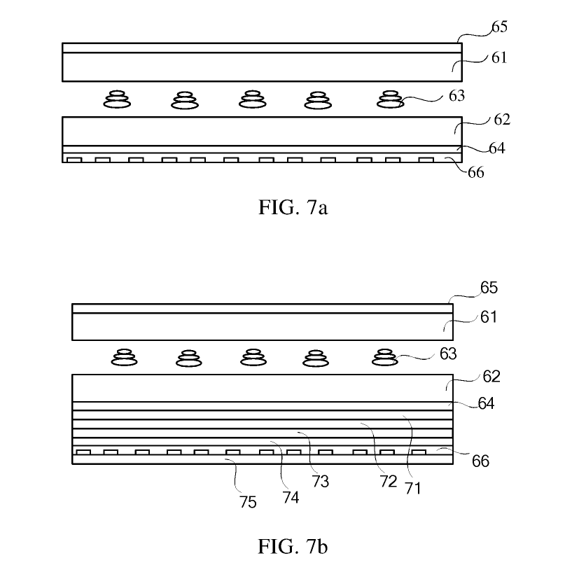

When the lower polarizer 64 does not include the first electrode and the second electrode for driving the quantum rod layer in the polarizer to emit light, the display panel further includes a backlight 66 used for display. As illustrated in FIG. 7a, the backlight 66 is disposed on a side of the lower polarizer 64 away from the array substrate 62.

Still another embodiment of the present invention also provides a display panel, which, as illustrated in FIG. 7b, further includes a first diffuser 71, a first prism sheet 72, a second prism sheet 73 and a second diffuser 74, disposed between an array substrate and a backlight, and a reflector 75 disposed on a side of the backlight away from the array substrate. Linearly polarized light reflected by quantum rods is converted into non-polarized light after the linearly polarized light passes through the diffusers, and the non-polarized light is reflected by the reflector and reutilized, so that the utilization rate of light can be further improved.

Description is given above by taking two diffusers and two prism sheets as an example. It should be noted that the diffusers and the prism sheets can also be other numbers. No limitation will be given here in the embodiment of the present invention.

Based on the same invention concept, the embodiment of the present invention further provides a display device, which includes the above-mentioned display panel.

In summary, the embodiments of the present invention provide a polarizer, a manufacturing method thereof and a display device. The polarizer includes a quantum rod layer, and the quantum rod layer includes a plurality of quantum rods arranged in a same direction (with consistent alignment). As the quantum rods have directivity and can perform linearly polarized emission, the quantum rod layer can convert light passing through the quantum rod layer into polarized light. Thus, the light loss caused by the adoption of absorption polarizers can be avoided; the utilization rate of the backlight can be improved; and meanwhile, brightness of the display panel can be improved, so that image display with high brightness and high color gamut can be achieved.

What have been described above are only specific implementations of the present invention, the protection scope of the present disclosure is not limited thereto. Any modifications or substitutions easily occur to those skilled in the art within the technical scope of the present disclosure should be within the protection scope of the present disclosure. Therefore, the protection scope of the present disclosure should be based on the protection scope of the claims.

This application claims the benefit of priority from Chinese patent application No. 201610004287.4, filed on Jan. 4, 2016, the disclosure of which is incorporated herein in its entirety by reference as a part of the present application.

1. A polarizer, comprising: a base substrate and a quantum rod layer disposed on a side of the base substrate, wherein the quantum rod layer comprises a plurality of quantum rods arranged in a same direction.

2. The polarizer according to claim 1, wherein a long-axis direction of each of the quantum rods is parallel with the base substrate, and long-axis directions of the plurality of quantum rods are arranged in the same direction.

3. The polarizer according to claim 1, further comprising a first electrode disposed on a side of the quantum rod layer away from the base substrate; and a second electrode disposed on a side of the quantum rod layer close to the base substrate.

4. The polarizer according to claim 1, further comprising a planarization layer disposed on a side of the quantum rod layer away from the base substrate.

5. The polarizer according to claim 1, wherein the quantum rod layer is made from any material selected from the group consisted of cadmium selenide, cadmium sulfide, zinc sulfide, zinc selenide, calcium sulfide and calcium selenide.

6. A display device, comprising a display panel comprising a color filter (CF) substrate, an array substrate, a liquid crystal layer disposed between the CF substrate and the array substrate, an upper polarizer disposed on a side of the CF substrate away from the liquid crystal layer, and a lower polarizer disposed on a side of the array substrate away from the liquid crystal layer, wherein at least the lower polarizer is the polarizer according to claim 1.

7. A manufacturing method of a polarizer, comprising: forming a pattern of a quantum rod layer on a base substrate, wherein the quantum rod layer comprises a plurality of quantum rods arranged in a same direction.

8. The manufacturing method according to claim 7, wherein a long-axis direction of each of the quantum rods is parallel with the base substrate, and long-axis directions of the plurality of quantum rods are arranged in a same direction.

9. The manufacturing method according to claim 7, wherein the quantum rod layer is formed by coating or crystal growth.

10. The manufacturing method according to claim 9, wherein forming the quantum rod layer by crystal growth comprises:
forming a quantum rod layer in a reaction chamber; and
transferring the quantum rod layer in the reaction chamber onto the base substrate.

11. The manufacturing method according to claim 10, further comprising: performing a planarization treatment on the quantum rod layer transferred onto the base substrate, so that the quantum rod layer is provided with a flat surface.

12. The manufacturing method according to claim 9, wherein forming the quantum rod layer by coating comprises:
forming a solution coating by coating a mixed solution containing quantum rods on the base substrate;
precuring the solution coating, so that viscosity of the solution coating satisfies a requirement of nanoimprint lithography; and
forming a quantum rod layer comprising regularly arranged quantum rods by stamping on the precured solution coating through the nanoimprint lithography.

13. The manufacturing method according to claim 12, further comprising: performing a planarization treatment on the quantum rod layer, so that the quantum rod layer is provided with a flat surface.

14. The manufacturing method according to claim 12, wherein a content of the quantum rods in the mixed solution is in a range of 1%-5%.

15. The manufacturing method according to claim 12, wherein the mixed solution further comprises an organic solvent and curable material.

16. The manufacturing method according to claim 15, wherein a content of the organic solvent in the mixed solution is in a range of 60%-80%.

17. The polarizer according to claim 2, further comprising a first electrode disposed on a side of the quantum rod layer away from the base substrate; and a second electrode disposed on a side of the quantum rod layer close to the base substrate.

18. The polarizer according to claim 2, further comprising a planarization layer disposed on a side of the quantum rod layer away from the base substrate.

19. The manufacturing method according to claim 7, further comprising: forming a first electrode on a side of the quantum rod layer away from the base substrate; and forming a second electrode on a side of the quantum rod layer close to the base substrate.

20. The manufacturing method according to claim 8, further comprising: forming a first electrode on a side of the quantum rod layer away from the base substrate; and forming a second electrode on a side of the quantum rod layer close to the base substrate.
